(19) United States
(12) Patent Application Publication
(10) Pub. No.: US 2024/0229852 A1
(43) Pub. Date: Jul. 11, 2024

(54) SAFETY FASTENER

(71) Applicants: Craig Richard Anstee, Bridgend (GB); Calvin Anstee, Bridgend (GB)

(72) Inventors: Craig Richard Anstee, Bridgend (GB); Calvin Anstee, Bridgend (GB)

(21) Appl. No.: 18/558,797

(22) PCT Filed: Apr. 26, 2022
(86) PCT No.: PCT/GB2022/051057

§ 371 Date: Nov. 3, 2023

(30) Foreign Application Priority Data
May 6, 2021 (GB) 2106469.6

(51) Int. Cl. F16B 31/02; F16B 31/06

(52) U.S. Cl. CPC F16B 31/025; F16B 31/06

(57) ABSTRACT

A safety fastener and a safety system are provided. The safety fastener indicates when a fastener is damaged, and the safety system indicates when a safety critical component is damaged. The fastener includes a load bearing body that encloses an inner volume filled with fluid, and a fluid sensor that detects the presence of the fluid within the inner volume. When the fluid sensor detects the fluid, a “fluid present” state is activated. If the fastener is damaged, fluid may escape from the inner volume, such that the fluid sensor leaves the “fluid present” state, indicating damage has occurred.

### FIELD OF THE INVENTION

The present invention concerns a safety fastener and/or a safety system. More particularly, but not exclusively, this invention concerns a safety fastener which indicates when the fastener is damaged, and/or a safety system which indicates when a safety critical component is damaged.

### BACKGROUND OF THE INVENTION

Fasteners such as bolts and pins are used in many safety critical situations. For example, large machinery such as grinders or chippers used to process wood in forestry applications include a number of pins which hold various parts of the machines together. Those pins experience significant and sometimes unpredictable loads during use. Due to fatigue, and/or manufacturing defects, the pins may fail during use, potentially causing significant and expensive damage to a machine which can take a long time to fix, especially out in the field. Failure may also create a safety hazard. Machine operators may inspect critical pins prior to use of a machine, but such inspections may be time consuming, and may not identify pins which have internal damage such as cracks that have not yet migrated to the surface of the pin, which may result in pin failure during use of the machine. Some pins may also be difficult to access for an inspection in the field, and/or defects may be obscured by other machine parts with which the pin interacts. In addition to visual inspections, pins may be inspected using various non-destructive testing techniques, for example using electromagnetic sensors and testing techniques, or ultrasound inspection. However, such testing is time consuming and may be expensive. Non-destructive testing may also be difficult to do in the field, where environmental conditions may be hostile, and the machine may be dirty, wet, or otherwise contaminated with materials being processed.

The skilled person will appreciate there are many other examples of fasteners being used where failure of the fastener would create a safety hazard, and/or cause expense or damage to a machine or structure including that fastener. For example, pins and/or bolts used in large engineering structures, such as bridges or buildings, pins and/or bolts used in fairground rides such as roller coasters and Ferris wheels, and pins and/or bolts used in automotive, aerospace, and nautical applications.

An example bolt is shown in U.S. Pat. No. 4,447,388. The bolt includes an inner chamber filled with a radioactive gas. Sensors are positioned in close proximity to the bolt which detect the escape of gas from the bolt, indicating that the bolt has cracked.

The present invention seeks to mitigate the above-mentioned problems. Alternatively, or additionally, the present invention seeks to provide an improved fastener and method of testing a fastener to detect damage prior to failure of the fastener.

### SUMMARY OF THE INVENTION

The present invention provides according to a first aspect, a fastener comprising a load bearing body, wherein the load bearing body encloses an inner volume filled with fluid, and a fluid sensor configured to detect the presence of the fluid within the inner volume, the fluid sensor being further configured such that in the event of detecting the fluid, a “fluid present” state is activated.

In the event that the fastener is damaged, such that a crack is created in the load bearing body, the fluid contained within the inner volume of the load bearing body may escape via the crack. This will result in the fluid sensor leaving the fluid present state. This change of state may be detected in various ways, as set out below, all of which will indicate that the load bearing body of the fastener has been damaged, and the fastener needs repair or replacement.

The positive check of the fluid present state brings an additional advantage that should the fluid sensor fail, the fluid present state will not be detected. Therefore, the detection of the fluid present state gives reassurance that both the load bearing body is crack free, and that the fluid sensor is working. If an alert was only triggered in the event of fluid not being detected, then if a fluid sensor was damaged, the fluid could escape through a crack without the crack damage then being detected.

The fluid present state may comprise the fluid sensor actively transmitting a fluid present signal. The fluid present signal may be detected by an external control unit, which may display the fluid present state of the fluid sensor. The external control unit may be a smart device, such as a smart phone or tablet. The external control unit may form part of the control apparatus of a machine in which the fastener is used. For example, if the fastener is used on a wood chipping or grinding machine, the external control unit may be located on the chipping or grinding machine.

The fluid present state may comprise the fluid sensor being in a passive state, such that when the fluid sensor is interrogated by an external control unit, a fluid present state is detected. Such an arrangement may reduce or remove power requirements for operating the fluid sensor.

Whether the fastener actively or passively indicates a fluid present state, the fastener can be checked for damage either continuously, or at a much higher frequency than conventional checking techniques. The fastener may also be checked when a machine of which the fastener is part is being operated, unlike conventional checking techniques. Therefore, damage to the fastener is much more likely to be detected prior to failure of the fastener. Preventative maintenance may then take place, avoiding the potential damage and/or danger caused by a fastener failure. Fasteners are often used in multiple arrays. As such, a fastener may be damaged without necessarily causing equipment to fail. However, if enough fasteners in an array are damaged, then an equipment failure may occur. The present invention allows detection of a damaged fastener in good time to allow replacement of the damaged fastener before equipment failure.

The fluid sensor may be wired to an external control unit. The fluid sensor may be wired to an external power supply. The fluid sensor may be wirelessly connected to an external control unit, for example using Bluetooth or other suitable near field communication apparatus and protocol. The fluid sensor may be wirelessly connected to an external power supply, for example using a conductive power transmission apparatus and protocol. The fastener may comprise an internal power supply connected to the fluid sensor, for example a battery.

The fastener may be a pin. The fastener may be bolt. The skilled person will appreciate that the invention may be applied to many different fasteners, provided those fasteners include a load bearing body. The invention is particularly applicable to fasteners which are safety critical, either to prevent damage to machinery, a structure, or property, or a user operating or located close to the machinery or structure. For example, the fastener may be a pin used in wood processing machinery, such as a grinder or chipper. The fastener may be a pin or bolt used in a fairground ride, for example a roller coaster or Ferris wheel. The fastener may be a pin or bolt used in aerospace, automotive, or nautical applications. For example, the fastener may be a pin or bolt used in a vehicle chassis arrangement.

The fluid may be held under higher than atmospheric pressure in the inner volume of the load bearing body. Holding the fluid under higher than atmospheric pressure may increase the speed with which the fluid escapes from a crack in the load bearing body, hence increasing the speed with which a crack is detected and a crack alert signal is triggered.

The fluid may be a liquid. The liquid may be brightly coloured to aid in visual detection of a crack in the fastener should the liquid pass through a crack in the load bearing body of the fastener. The liquid may be chosen such that the liquid fluoresces under UV light to aid in visual detection of a crack in the load bearing body of the fastener. The liquid may be chosen to foam, bubble, or solidify in the event of escaping through a crack in the load bearing body and becoming exposed to air.

The fluid sensor may be a level sensor, for example a level sensor arranged to detect the presence of a liquid above a threshold level within the inner volume of the load bearing body. Should the liquid level within the inner volume of the load bearing body drop below a threshold level, for example due to leakage through a crack, the fluid sensor may move out of the fluid present state.

The fluid may be a gas. A gas may escape through a crack in the load bearing body more quickly than a liquid, thereby resulting in quicker detection of a crack in the load bearing body.

The fluid sensor may be a pressure sensor, for example, a pressure sensor arranged to detect pressure above a threshold level within the inner volume of the load bearing body. Should the pressure within the inner volume of the load bearing body drop below a threshold level, for example due to leakage through a crack, the fluid sensor may move out of the fluid present state.

The fluid may be an inert liquid or gas. The fluid may be chosen to have little or no environmental impact in the event of the fluid escaping from the load bearing body. For example, the fluid may be water, or carbon dioxide gas. The fluid may be chosen such that no damage to equipment surrounding the fastener is caused by the fluid in the event of the fluid escaping from the load bearing body.

The fastener may comprise a first part and a second part. The first part may be mechanically joined to the second part, for example via a threaded connection between the first part and second part. The first part may be screwed into the second part, or vice versa. The first part and second part may comprise the load bearing body. One or both of the first part and second part may define the inner volume of the load bearing element. For example, the second part may comprise an inner chamber, and the first part may cap the inner chamber when mechanically joined to the second part. One of the first part and second part may comprise the fluid sensor.

The fastener may comprise a plurality of inner volumes and at least one corresponding fluid sensor configured to detect the presence of the fluid within the inner volumes, the at least one fluid sensors being further configured such that in the event of detecting the fluid, a “fluid present” state is activated.

The inner volume may be located co-axial with the central longitudinal axis of the fastener. Alternatively, or additionally, there may be a plurality of inner volumes located towards the outer circumference of the fastener. The inner volumes may be located such that they indicate when the outer circumference of the fastener has worn to a set point. Such an arrangement may prevent overly worn fasteners being used, which would bring a risk of fastener failure. Such an arrangement may be beneficial in high-wear fasteners such as fifth wheel pins. The plurality of inner volumes may be in fluid communication, for example via a fluid reservoir, or may comprise distinct inner volumes that do not connect with each other. When the plurality of inner volumes are in fluid communication, a single fluid sensor may be provided. When the plurality of inner volumes are not in fluid communication, a fluid sensor may be provided for each inner volume.

The fastener may comprise a light unit, for example an LED. The light unit may be activated when the fastener is in a fluid present state, thereby allowing easy visual confirmation that the fastener is not cracked. The light unit may be activated when the fastener is not in the fluid present state, for example flashing or emitting light of a different colour to when the fastener is in the fluid present state. The fastener may comprise a sound unit, for example an audible alarm. The sound unit may be activated when the fastener is in the fluid present state, for example sounding a regular beeping, to allow easy audible confirmation that the fastener is not cracked. The sound unit may be activated when the fastener is not in the fluid present state, for example emitting an audible alarm signal to alert a user of damage to the fastener.

According to a second aspect, the invention provides a method of detecting a crack in a load bearing body of a fastener according to the first aspect of the invention, the method comprising the steps of observing the fastener, and in the event of observing the fastener is not in the fluid present state, activating an alarm signal. The alarm signal may cause a visible or audible alarm to be triggered. For example, the alarm signal may activate a light associated with the fastener, such that a user will see that the fastener requires attention. Alternatively, or additionally, an audible signal such as a buzzer may be activated, such that a user will be informed that the fastener requires attention. The alarm signal may result in a notification being sent to a control unit, for example a control unit forming part of a machine including the fastener, or a remote control unit associated with the machine, or to a smart device such as a smart phone or tablet. Alternatively, or additionally, the alarm signal may cause a shutdown of a machine including the fastener, to automatically prevent any further damage occurring. The alarm signal may need to be cleared, for example by physically inspecting the fastener or replacing the fastener, before the machine may be operated again. Such an arrangement may prevent machines being damaged due to users ignoring the alarm signal.

The fastener may comprise an inner volume and a detector bar located within the inner volume. The inner volume may correspond to the inner volume filled with fluid, or may be a separate inner volume. If the fastener is deformed, the detector bar may contact a surface defining the inner volume. Such contact may be detected and prompt a deformation alert or notification to be triggered.

According to a third aspect, there is provided a fastener comprising a load bearing body, the load bearing body comprising an inner volume defined by an internal surface of the load bearing body, and a detector bar located within in the inner volume, such that, in a normal state, the detector bar does not make contact with the internal surface of the load bearing body, and in a deformed state, the detector bar does make contact with the internal surface of the load bearing body.

The deformed state may comprise the load bearing body being exposed to excessive load, causing the load bearing body to bend or twist out of shape. When the load bearing body is deformed beyond a certain point, the fastener may no longer be suitable for use, for example due to an increased risk of failure.

When the detector bar makes contact with the internal surface of the load bearing body, the fastener may be configured to trigger an alert or notification. For example, the internal surface of the load bearing body and the detector may comprise conductive materials. When the detector bar contacts the internal surface of the load bearing body, a circuit may be completed, which may trigger an alert, for example, a visible or audible alert, or a notification, for example a notification being sent to a smart device. The fastener may comprise a light emitting device, or a sound emitting device. The fastener may comprise a communications unit, for example a wireless communications unit. Alternatively, the communications unit may be a wired communications unit. The fastener may comprise a power source, for example a battery.

The detector bar may comprise a detector contact extending away from the longitudinal axis of the detector bar. Such an arrangement may allow the tuning of the fastener arrangement to particular spacings which indicate particular deformation of the fastener. The detector bar may comprise a plurality of detector contacts located spaced apart along the detector bar. Such an arrangement may allow for different levels of deformation to be detected. For example, a centrally located detector contact may contact the internal surface of the load bearing body when the fastener is at the allowed level of deformation. A second detector contact may be located spaced from the centrally located detector contact and be arranged to contact the internal surface of the load bearing body when the fastener is beyond the allowed level of deformation. The skilled person will appreciate that a number of detector contact points may be located spaced apart from one another in order to provide additional degrees of accuracy of the indication of deformation of the fastener.

According to a fourth aspect, the invention may provide a component, the component comprising a body, wherein the body encloses an inner volume filled with fluid, and a fluid sensor configured to detect the presence of the fluid within the inner volume, the fluid sensor being further configured such that in the event of detecting the fluid, a “fluid present” state is activated

The component may be any component for which it is desirable to detect damage to the component. For example, the component may be a wheel hub of an aircraft, train, or automotive vehicle.

According to a fifth aspect of the invention, there is provided a fastener, the fastener comprising a load bearing body, wherein the load bearing body encloses a first inner volume filled with fluid, and a fluid sensor configured to detect the presence of the fluid within the first inner volume, the fluid sensor being further configured such that in the event of detecting the fluid, a “fluid present” state is activated, the fastener further comprising a second inner volume, the inner volume being defined by an internal surface of the load bearing body, and a detector bar is located within in the second inner volume, such that, in a normal state, the detector bar does not make contact with the internal surface of the load bearing body, and in a deformed state, the detector bar does make contact with the internal surface of the load bearing body.

Such an arrangement provides a fastener which is able to indicate damage such as a crack or excess wear, and also deformation of the fastener. The fifth aspect of the invention may comprise any of the features of the first, second, third, or fourth aspects of the invention.

According to a sixth aspect, there is provided a fastener comprising a load bearing body, wherein the load bearing body encloses an inner volume filled with gas, and a liquid sensor configured to detect the presence of liquid within the inner volume, the liquid sensor being configured such that in the event of detecting liquid, a liquid present state is activated. Such an arrangement may be used to detect cracks in fasteners used whilst submerged in liquid. For example, if the fastener was under water, and a crack developed in the load bearing body, the inner volume will be compromised. This may result in the gas escaping from the inner volume and being replaced with water, which will be detected by the liquid sensor. As in the previously described embodiments of the invention, this may trigger an alert or notification, such that the crack is detected and the fastener may be replaced or repaired.

It will of course be appreciated that features described in relation to one aspect of the present invention may be incorporated into other aspects of the present invention. For example, the first aspect of the invention may incorporate any of the features described with reference to the other aspects of the invention and vice versa.

### DESCRIPTION OF THE DRAWINGS

Embodiments of the present invention will now be described by way of example only with reference to the accompanying schematic drawings of which:

FIG. 1 shows a side view of a shear bolt according to a first embodiment of the invention;

FIG. 2 shows a cross-sectional view of the shear bolt of FIG. 1;

FIG. 3 shows a side view of a threaded bolt according to a second embodiment of the invention;

FIG. 4 shows a cross-sectional view of the threaded bolt of FIG. 3;

FIG. 5 shows a side view of a threaded bolt according to a third embodiment of the invention;

FIG. 6 shows a cross-sectional view of the threaded bolt of FIG. 5; and

FIG. 7 shows a safety system according to a fourth embodiment of the invention;

FIG. 8 shows a cross-sectional view of a fastener comprising a deflector bar with multiple contact points and a plurality of inner volumes according to a fifth embodiment of the invention;

FIG. 9 shows a cross-sectional view of a fastener similar to that shown in FIG. 8, without the plurality of inner volumes; and

FIG. 10 shows a cross-sectional view of a fastener with multiple inner volumes according to a sixth embodiment of the invention.

### DETAILED DESCRIPTION

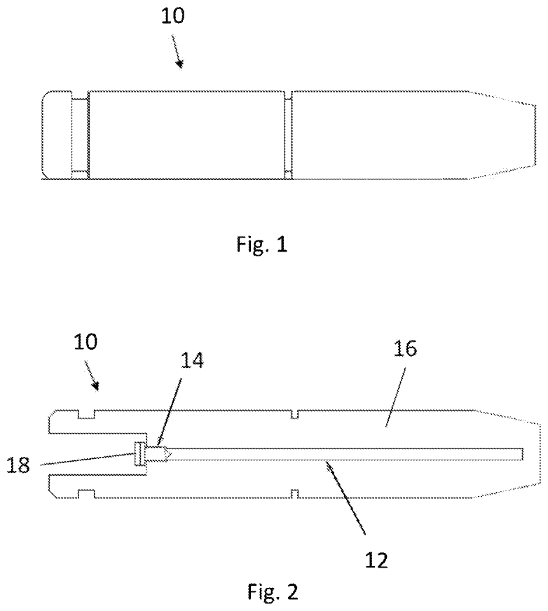

FIGS. 1 and 2 show a shear bolt 10. The shear bolt 10 comprises a load bearing body 16 including an inner volume 12. The inner volume 12 is defined by an internal surface of the load bearing body 16, along with a sensor element 14 located such that the inner volume 12 is plugged so as to be fluid-tight. In this embodiment, the sensor element 14 is a pressure sensor threaded and screwed into position. In other embodiments, alternative fixing methods may be used, for example provision of an interference fit. The inner volume 12 is filled with a fluid, in this case carbon dioxide gas under pressure, and the sensor element 14 is arranged to detect the increased pressure compared to atmospheric pressure. When the increased pressure is detected, the sensor is in a “fluid present” state. If the load bearing body 16 cracks, such that the inner volume 12 defined by the inner surface of the load bearing body 16 is no longer fluid tight, the fluid will escape from the inner volume 12 and the sensor element 14 will no longer detect the increased pressure relative to atmospheric pressure, and will move out of the fluid present state. The sensor element 14 includes a power source and a light unit 18. When in the fluid present state, the light unit 18 is arranged to be activated to emit light. Therefore, the sensor element 14 provides a positive confirmation that the sensor is in the fluid present state. This indicates both that the sensor is working, and the shear bolt 10 is not cracked. When the light unit 18 is not illuminated, it is apparent that either the shear bolt 10 is cracked, or the sensor element 14 or light unit 18 is not functioning. In either case, the shear bolt 10 required closer inspection and possible replacement.

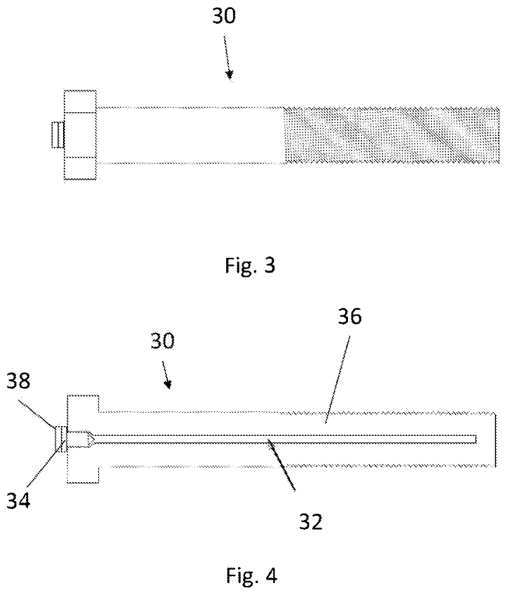

FIGS. 3 and 4 show a bolt 30 with a load bearing body 36, an inner volume 32 filled with fluid, and a sensor element 34. The arrangement is similar to that described with reference to FIGS. 1 and 2, though applied to a different type of fastener. The sensor element 34 includes a communications unit 38 which is arranged to send a “fluid present” signal when the sensor element 34 is in the fluid present state, and a “fluid not present” signal when the sensor element is not in the fluid present state. In this embodiment, the signal is actively sent at regular intervals. The signal is wirelessly sent via any suitable wireless communications protocol, as would be understood by a skilled person. The signal may be received by a smart device, for example a control panel or a phone or tablet device. Such an arrangement allows for remote monitoring of the integrity of a fastener where it may be difficult to visually observe the fastener. In an alternative arrangement, the communications unit 38 may be arranged to be in a passive state, where the state of the sensor element is detected by interrogation of the communications unit 38 by a suitable wireless communication device. A passive arrangement may require less power storage in the fastener than an active arrangement, which could be particularly advantageous if the fastener is not connected to a mains power supply, for example being provided with a battery.

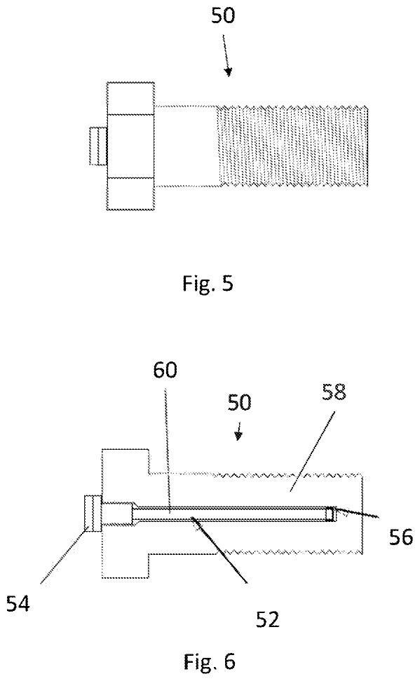

FIGS. 5 and 6 show a bolt 50. The bolt 50 comprises a load bearing body 58 with an inner volume 52 defined by an internal surface of the load bearing body 58. A sensor element 54 is provided, which includes an elongate rod 60 which extends along the inner volume 52. When the bolt 50 is in a normal, undeformed state, the elongate rod does not contact the internal surface of the load bearing body 58. However, the spacing between the elongate rod 60 and the internal surface of the load bearing body 58 is small, such that deformation of the load bearing body 58 results in contact being made between the elongate rod 60 and the internal surface of the load bearing body 58. The internal surface of the load bearing body 58 and the elongate rod 60 are both made of conductive material, and the sensor element is arranged to run a current into the elongate rod 60 to detect contact between the elongate rod 60 and the internal surface of the load bearing body 58. In the present arrangement, when no contact is made between the elongate rod 60 and the internal surface of the load bearing body 54, the sensor element 54 is in a “normal” state. This normal state may result in a normal notification or signal such as a light activation as described above, being activated. As in the above embodiments, such an arrangement indicates that both the sensor element 54 is working, and the bolt 50 is undeformed. An insulating washer 56 is provided at an end of the elongate rod 60 to ensure that vibration of the bolt 50 does not cause the elongate rod 60 to touch the internal surface of the load bearing body 58, potentially causing a false indication of damage to the bolt 50.

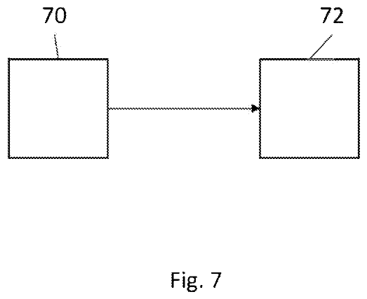

FIG. 7 shows a safety system including a fastener 70, which may be as described with reference to any of FIGS. 1 to 6. The fastener 70 comprises a sensor element with a wireless communications unit, the wireless communications unit arranged to send an indication of the state of the fastener 70 to a receiving unit 72. The receiving unit 72 may be a control screen which forms part of a machine or structure of which the fastener 70 is a part. Alternatively, the receiving unit 72 may be a smart device, such as a phone or a tablet. In an alternative embodiment, the communications unit of the fastener 70 may be wired to the receiving unit 72.

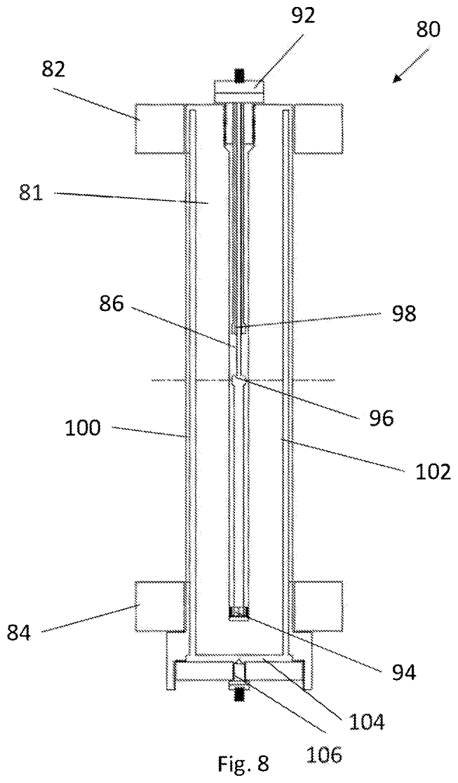

FIG. 8 shows a fastener 80 extending between a first mounting point 82 and a second mounting point 84 of the same body. The fastener 80 is threaded (not shown) to allow engagement with complementary threads in the first mounting point 82 and second mounting point 84. The skilled person will appreciate that in alternative embodiments, the fastener may be secured by other fixing mechanism. An elongate rod 86 extends through a void 88 along the central longitudinal axis of the load bearing body 81 of the fastener 80, and forms part of a sensor assembly 90, with a detector unit 92 located at one end of the fastener 80. The elongate rod 86 is isolated from the main body of the fastener 80 by an insulated washer 94, which also acts to dampen any vibrations experienced by the fastener 80, which could potential trigger false readings. The insulated washer 94 is also configured to isolate the elongate rod 84 from deformation of the load bearing body 81 of the fastener. The elongate rod 86 further comprises a first contact portion 96, and a second contact portion 98. The first contact portion 96 is located approximately in the centre of the length of the fastener 80, and the second contact portion 98 is located closer to an end of the fastener 80. If the fastener 80 is deformed by a load placed upon the load bearing body 81, the first contact portion 96 will contact the main body of the fastener. If the fastener 80 is deformed further, the second contact portion 98 will contact the main body of the fastener. The first contact portion 96 and second contact portion 98 are electrically isolated from each other. By running a current along the elongate rod to each of the first contact portion 96 and second contact portion 98, it can be detected when the first contact portion 96 and/or second contact portion 98 touches the main body of the fastener. This may then trigger an alarm or alert as previously described, indicating the deformation of the fastener and allowing for closer inspection or replacement. By including a number of contact portions, the level of deformation may be indicated. For example, the first contact portion 96 may be configured to indicate an allowed level of deformation, whereas the second contact portion 9 may be configured to indicate the deformation has gone beyond the maximum limited and the fastener 80 needs replacement. The fastener 80 also comprises a first inner volume 100 and second inner volume 102 extending along the length of the fastener 80, towards the circumferential edge of the fastener 80 The first inner volume 100 and second inner volume 102 are in fluid communication with each other via a fluid reservoir 104. A fluid sensor 106 is associated with the fluid reservoir 104 and configured to detect a “fluid present” stage and a “fluid not present” state. When in the “fluid present” state, the fluid sensor 106 is configured to indicate such by activating a light, and/or transmitting a “fluid present” state to a remote device, for example a smart phone or computer. This provides confidence both that there is fluid present in the inner volumes 100 and 102, and the sensor 106 is operational. In the event of the fastener 80 being damaged, for example due to cracking, fluid will escape from the inner volumes 100 and 102, and the sensor will move into the “fluid not present” state. The fluid sensor 106 will then no longer activate a light, and/or will cease transmitting the “fluid present” state to a remote device, and the absence of the positive confirmation of fluid will indicate that the fastener may be damaged and requires inspection. In the event of the fluid sensor 106 failing, there will also be an absence of the positive confirmation of fluid present, which will lead to the fastener being examined and the malfunctioning sensor may be detected. As the skilled person will appreciate, the fluid may be a liquid or gas. Preferably, the fluid is present in the inner volumes 100 and 102 at a greater pressure than the ambient pressure. Therefore, if a fastener is cracked or worn such that an inner volume 100, 102, is compromised, the fluid will escape under pressure, therefore triggering a “fluid not present” state. By locating the first inner volume 100 and second inner volume 102 towards the circumferential edge of the fastener 80, excess wear of the fastener 80 may be detected.

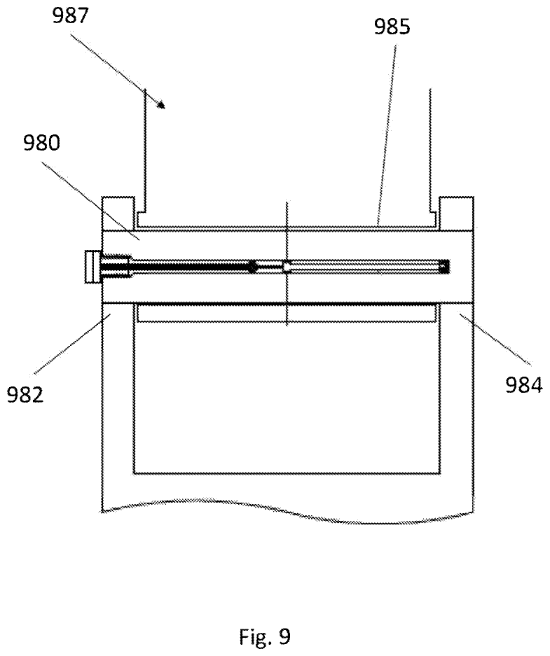

FIG. 9 shows a fastener 980 extending between a first mounting point 982 and second mounting point 984 of the same body. The fastener 980 also extends through a bore 985 of a separate body 987, securing the two bodies together. The internal arrangements of the fastener 980 match those of the fastener 80 described with reference to FIG. 8, except that only the deflection bar is present, not the inner volumes filled with fluid.

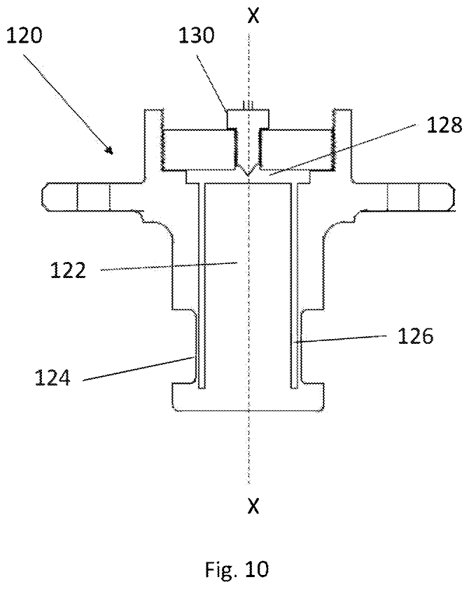

FIG. 10 shows a cross-sectional view of a fastener 120 according to the present invention. The fastener 120 is a fifth wheel pin, as commonly used in the haulage industry. The fastener 120 comprises a main body 122 with a first inner volume 124 and second inner volume 126. The fastener 120 has a longitudinal axis X-X, and the first inner volume 124 and second inner volume 126 extend in the direction of the longitudinal axis X-X, towards the circumferential edge of the main body 122. The first inner volume 124 and second inner volume 126 are in fluid communication with a shared fluid reservoir 128, with fluid filling the inner volumes and fluid reservoir, and a fluid sensor 130 is positioned to plug the fluid reservoir 128. The fluid is present at a higher pressure than the ambient pressure, such that if the inner volumes are compromised, the fluid escapes. In such an arrangement, the fluid sensor 130 is a pressure sensor. The fluid sensor 130 is further configured to detect the presence of fluid within the fluid reservoir 128. When fluid is detected, the fluid sensor 130 enters a “fluid present” state, in which a fluid present signal is transmitted to an external monitoring device. When fluid is not detected, or when the fluid sensor 130 fails, the fluid present signal ceases transmission, thereby notifying a user of a potential problem with the fastener 120. The first inner volume 124 and second inner volume 126 are located towards the circumferential edge of the main body 122 at a position chosen to indicate a certain wear of the fastener 120. The inner volumes are small bores within the main body 122, and have little or no effect on the overall strength of the fastener 120. When the main body 122 has been worn to a set point, one or more of the inner volumes will be compromised, and the fluid present will escape pressure. This will result in the fluid sensor 130 moving to a “fluid not present” state, which is transmitted to a user as previously described. Therefore, excess wear of the fastener 120 is indicated without requiring constant checking of the fastener 120 during use.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

A similar arrangement to that shown with respect to fasteners in FIGS. 1 to 6, may be applied to any load bearing component. For example, a similar arrangement may be applied to a wheel hub of an automotive vehicle, or any other vehicle or transportation machine. Alternatively, a similar arrangement may be applied to load bearing structures such as bridge or building components.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A fastener comprising a load bearing body, wherein the load bearing body encloses an inner volume filled with fluid, and a fluid sensor configured to detect the presence of the fluid within the inner volume, the fluid sensor being further configured such that in the event of detecting the fluid, a “fluid present” state is activated.

2. A fastener according to claim 1, wherein the fluid sensor is wired to an external control unit.

3. A fastener according to claim 1, wherein the fluid sensor is wired to an external power supply.

4. A fastener according to claim 1, wherein the fluid sensor is wirelessly connected to an external control unit.

5. A fastener according to claim 1, wherein the fluid sensor is wirelessly connected to an external power supply.

6. A fastener according to claim 1, wherein the fastener comprises an internal power supply connected to the fluid sensor.

7. (canceled)

8. (canceled)

9. A fastener according to claim 1, wherein the fluid is held under higher than atmospheric pressure in the inner volume of the load bearing body.

10. A fastener according to claim 1, wherein the fluid is a liquid.

11. A fastener according to claim 1, wherein the fluid is a gas.

12. A fastener according to claim 1, comprising a first part and a second part, wherein the first part is mechanically joined to the second part.

13. (canceled)

14. A fastener according to claim 12, wherein the first part and second part comprise the load bearing body.

15. A fastener according to claim 14, wherein one or both of the first part and second part define the inner volume of the load bearing element.

16. A fastener according to claim 15, wherein one of the first part and second part comprise the fluid sensor.

17. A fastener as claimed in claim 1, comprising a plurality of inner volumes and at least one corresponding fluid sensors configured to detect the presence of the fluid within the inner volumes, the at least one fluid sensor being further configured such that in the event of detecting the fluid, a “fluid present” state is activated.

18. (canceled)

19. (canceled)

20. A fastener as claimed in claim 17, wherein the plurality of inner volumes are in fluid communication.

21. A fastener as claimed in claim 17, wherein the plurality of inner volumes are distinct inner volumes that do not connect with each other.

22. (canceled)

23. A method of detecting a crack in a load bearing body of a fastener according to claim 1, the method comprising the steps of observing the fastener, and in the event of observing the fastener is not in the fluid present state, activating an alarm signal.

24. A method as claimed in claim 23, wherein the alarm signal causes a visible or audible alarm to be triggered.

25. A method as claimed in claim 23, wherein the alarm signal causes a notification to be sent to a control unit or a smart device.

25. (canceled)

26. (canceled)

27. (canceled)

28. (canceled)

29. (canceled)

30. (canceled)

31. A method as claimed in claim 23, wherein the alarm signal causes a shutdown of a machine including the fastener.
